(19) United States
(12) Patent Application Publication
(10) Pub. No.: US 2017/0132380 A1
(43) Pub. Date: May 11, 2017

(54) SERVICE MONITORING AND EVALUATION SYSTEM, METHOD AND PROGRAM PRODUCT

(71) Applicant: International Business Machines Corporation, Armonk, NY (US)

(72) Inventors: Ana P. Appel, Sao Paulo (BR); Luis G. Moyano, RIO DE JANEIRO (BR); Vagner F. De Santana, Sao Paulo (BR)

(73) Assignee: International Business Machines Corporation, Armonk, NY (US)

(21) Appl. No.: 14/935,498

(22) Filed: Nov. 9, 2015

(51) Int. Cl. G06F 19/00; G06F 17/30

(52) U.S. Cl. CPC G06F 19/327; G06F 17/30864

(57) ABSTRACT

A service monitoring and evaluation system, method and program product for monitoring and evaluating services, e.g., healthcare. A client or patient timeline storage stores social media information for any Event of Interest (EoI) for patients, including information indicating the effectiveness of patient treatment being provided by healthcare providers. Healthcare providers have access to the patient timeline storage for respective patients to track treatment. A monitoring bot continually searches social media for patient EoIs, and extracts treatment effectiveness information from the EoIs and adds any new information to the patient timeline storage. An evaluation bot receives requests for provider evaluation, filters patient timeline information for treatment effectiveness, and rates and ranks the treatment effectiveness for the requestor.

### BACKGROUND OF THE INVENTION

Field of the Invention

The present invention is related to feedback and rating systems and more particularly to using feedback to monitor prescribed treatment effectiveness and subsequently rating the treatment.

Background Description

The Internet and social media have provided numerous avenues for evaluating and rating goods and services. Once evaluated and rated, potential consumers can use those evaluations and ratings to make decisions for subsequent consumption. Amazon.com, for example, provides for purchasers to review products and includes the reviews with subsequent product listings. In another example, Yelp allows members to review various commercial businesses and makes those reviews available to everyone. Angie's List provides a similar review and ranking for contractor services. Similar rating sites are available for, professional service providers, such as, lawyers, doctors and dentists. All of these reviewing services use voluntary, rather subjective, feedback from client/patient customers. Especially with a healthcare provider, such as a doctor, the patient-reviewer is reviewing the provider based on personal perception, e.g., how pleasant the office visit went or how quickly he/she got through to the provider. These subjective reviews are seldom based on the effectiveness of the service, for example, indicating whether a doctor accurately diagnoses problems and quickly resolves them.

Typically, when a patient visits a doctor for an illness and reports symptoms, the doctor diagnoses a medical problem and prescribe treatment. Unless the doctor prescribes a hospital stay with specific monitoring devices/sensors or periodic return visits, the doctor typically has no feedback with regard to the effectiveness of the treatment. Without follow-on monitoring, the doctor assumes that the treatment is effective, unless the patient returns for additional treatment. During treatment the doctor is without any real insight into whether the patient's symptoms are abating, the patient's reaction to any prescribed drugs, or even how well the patient is following the prescribed treatment, much less the effectiveness of the treatment. So, unless and until the patient returns for additional diagnosis and treatment there may be no monitoring, and the doctor may think that a marginal treatment is much more effective than it really has been.

Thus, there is a need for monitoring prescribed treatment effectiveness and ranking treatment providers based on effectiveness; and more particularly, for monitoring patient activities transparently to evaluate prescribed treatment effectiveness, and subsequently rank aspects of treatment based on past effectiveness.

### SUMMARY OF THE INVENTION

A feature of the invention is that patient activities may be transparently monitored to evaluate prescribed treatment effectiveness;

Another feature of the invention is on-going gathering of health information related to any Event of Interest (EoI) from social media and social networks in combination with other general life events;

Yet another feature of the invention is a patient database including EoI information indicating health information of patients in, and through, treatment;

Yet another feature of the invention is a searchable patient database for rating patient treatment and ranking provider effectiveness.

The present invention relates to a service monitoring and evaluation system, method and program product for monitoring and evaluating services, e.g., healthcare. A client or patient timeline storage stores social media information for any Event of Interest (EoI) for patients, including information indicating the effectiveness of patient treatment being provided by healthcare providers. Healthcare providers have access to the patient timeline storage for respective patients to track treatment. A monitoring bot continually searches social media for patient EoIs, and extracts treatment effectiveness information from the EoIs and adds any new information to the patient timeline storage. An evaluation bot receives requests for provider evaluation, filters patient timeline information for treatment effectiveness, and rates and ranks the treatment effectiveness for the requestor.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 depicts a cloud computing node according to an embodiment of the present invention;

FIG. 2 depicts a cloud computing environment according to an embodiment of the present invention;

FIG. 3 depicts abstraction model layers according to an embodiment of the present invention;

FIG. 4 shows an example of gathering health information related to any Event of Interest (EoI) from social media and social networks and using the gathered information according to a preferred embodiment of the present invention;

FIG. 5 shows an example of the treatment phase for a client (patient) visiting a doctor or medical facility for a new ailment.

### DESCRIPTION OF PREFERRED EMBODIMENTS

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is further understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed and as further indicated hereinbelow.

Peer-to-peer (P2P) computing or networking is a distributed application architecture that partitions tasks or workloads between peers. P2P network devices, or peers, are network nodes of equally privileged, equipotent participants in the P2P application. Peers may make a portion of their resources, such as disk storage, directly available to other network participants, without the need for central coordination by servers or stable hosts. Typically, peers are both suppliers and consumers of resources. This is in contrast to the traditional client-server model in which the consumption and supply of resources is divided.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

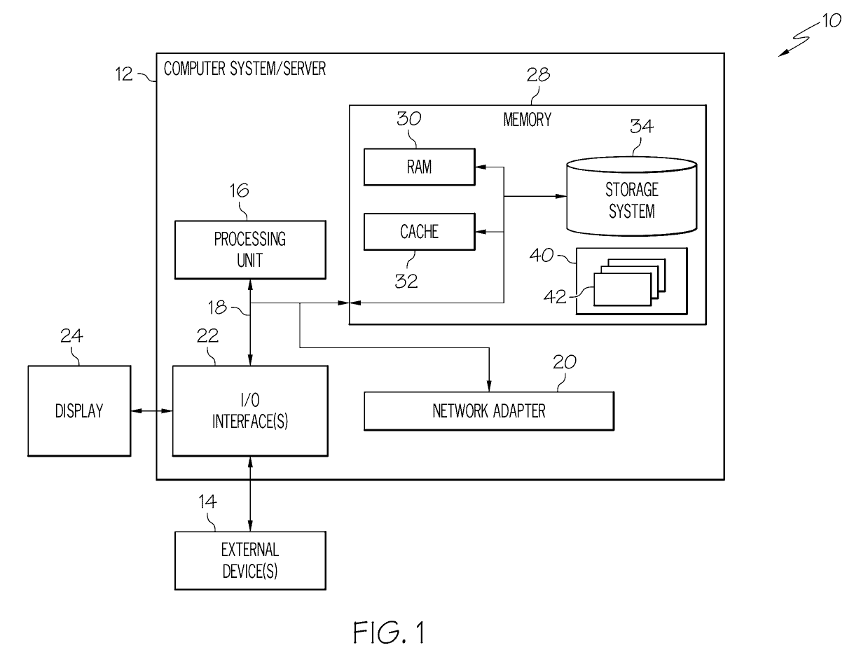

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

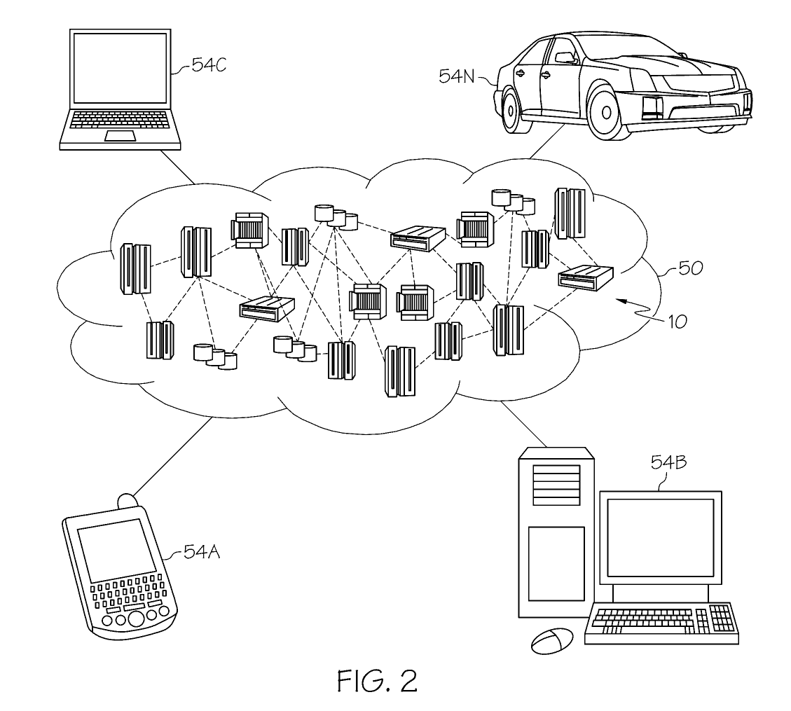

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

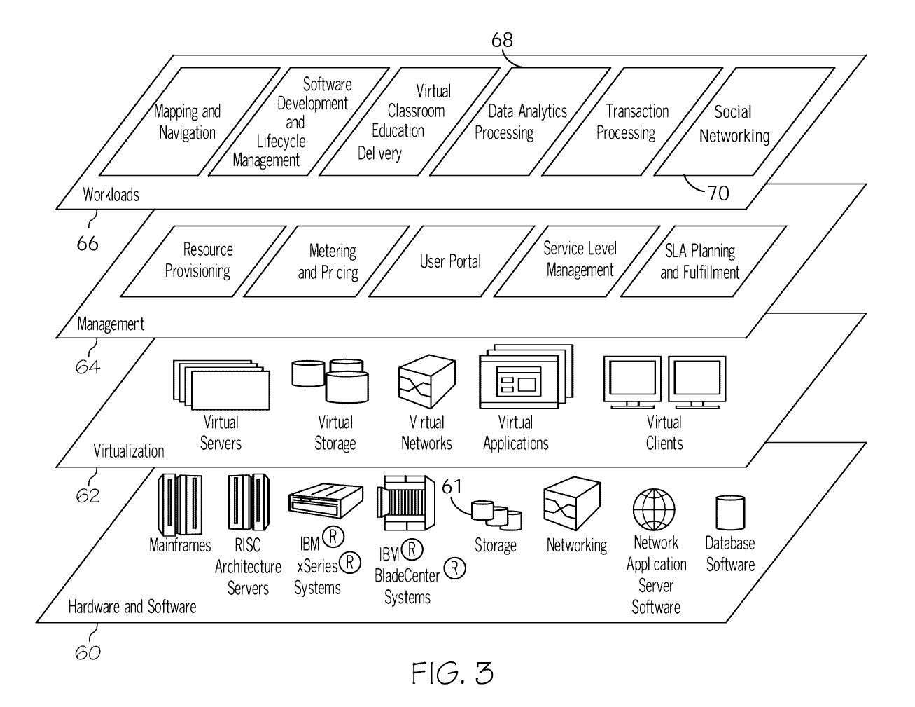

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices 61; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks 63, including virtual private networks; virtual applications and operating systems; and virtual clients.

In one example, management layer 64 may provide the functions described below. Preferred, context aware resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Preferred, context aware service level management provides cloud computing resource allocation and management such that required service levels are met. Preferred, context-aware Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing 68; transaction processing; and social networking 70, e.g., Facebook, Twitter and Myspace.

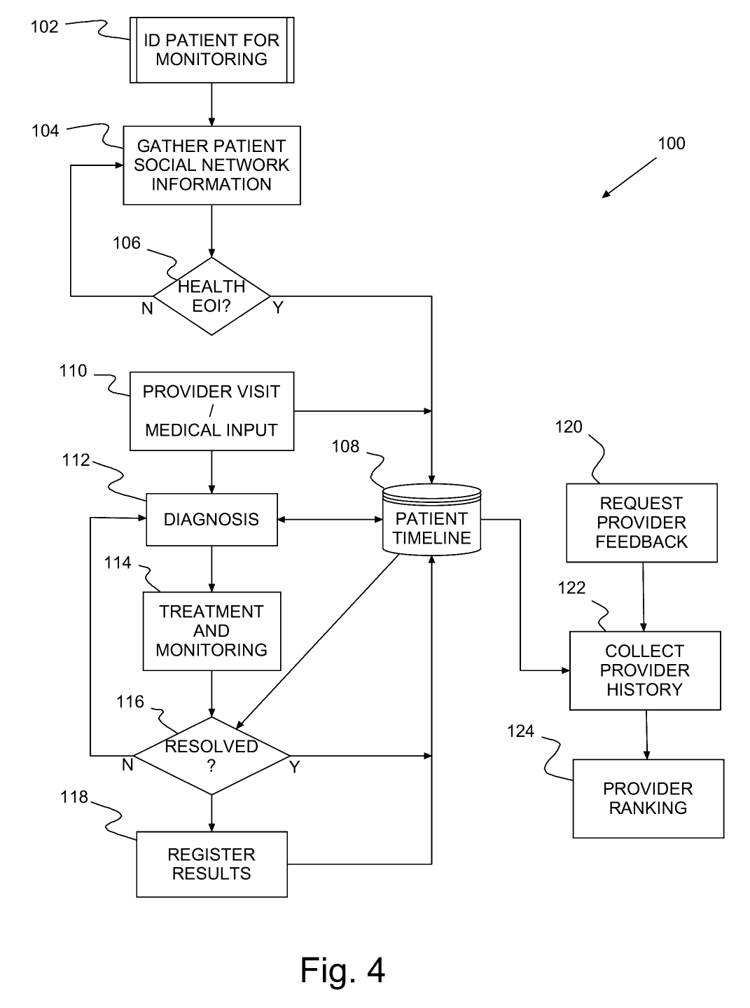

FIG. 4 shows an example 100 of gathering health information related to any Event of Interest (EoI) from social media and social networks 70 by monitoring and evaluation system(s) 10, and using the gathered information for evaluating and ranking providers, according to a preferred embodiment of the present invention. It should be noted that although described with regard to healthcare and healthcare services and providers, the present invention has application to transparently monitoring any service being provided by a service provider and, subsequently, evaluating and ranking service providers providing the service.

In a first phase a prospective provider client, e.g., a medical office patient, is identified 102 either by the patient or by the medical provider, e.g., assigned an identification (ID). A monitoring agent or web bot searches 104 social media (70 in FIG. 3) for content regarding the identified patient until a health related EoI occurs 106, e.g., indicating the manifestation of disease/symptoms. Web bots are well known and commonly used in the art to quickly complete repetitive jobs. The monitoring bot may be present locally on a local computer (e.g., 10 in FIG. 1) at a provider's location, or remotely, e.g., analytics processing 68 on a cloud computer in cloud 50 of FIG. 2. When the monitoring bot locates an EoI in social media, the monitoring bot registers the EoI in a patients' timeline database 108, e.g., in cloud 50 storage 61.

In the next phase, the treatment phase, coincident with registering the EoI or shortly thereafter, the patient or, optionally, the monitoring bot schedules 110 an appointment for an office visit. If, for example, the monitoring bot identifies information in an EoI indicating an illness, the monitoring bot may schedule 110 the appointment. During the appointment the provider diagnoses the patient's problem, logs the office visit diagnosis and logs any prescribed treatment 112, which is entered in the patient's timeline database 108, e.g., automatically or by the monitoring bot. Thereafter, during treatment 114 the monitoring bot follows patient on social media for any EoI indicating how treatment is progressing, and logs results. The logged results enrich the information previously available to the patients' healthcare providers. When treatment 114 concludes 116, the monitoring bot registers 118 and logs the final results.

Subsequently, a third, evaluation phase provides for evaluating treatment aspects from collected timeline database 108 information to analyze the overall treatment. A requestor places an analysis request 120 for a results evaluation with an evaluation bot. The evaluation bot filters the EoI information to collect 122 treatment information and returns 124 that filtered information to the requestor.

So, for example, a new patient 102 registers with a medical office or practice and signs the necessary authorizations. The office staff may register the patient as a client, e.g., on a local computer, or the patient may register for an ID from an on line Internet site. Alternately, for example, someone may purchase insurance and the insurance company may register the client ID. Preferably, as each client registers or is registered, the client identifies social network presences on the World Wide Web.

The monitoring bot continually searches/crawls 104 the Web identifying social network presences for the registered client(s) and monitors the web presences. Thereafter, the monitoring bot filters client social network presence information for any health related EoI 106. So, for example, the monitoring bot may locate a status that indicates one client is home sick, and another is out and about with a social media status of “good to go.” The monitoring bot applies sentiment analysis to identify medical or treatment information reflected in the EoIs to determine that the first client is still under the weather, while the second is responding well to treatment. The monitoring bot logs each identified EoI with any identified medical information in the patients' timeline database 108.

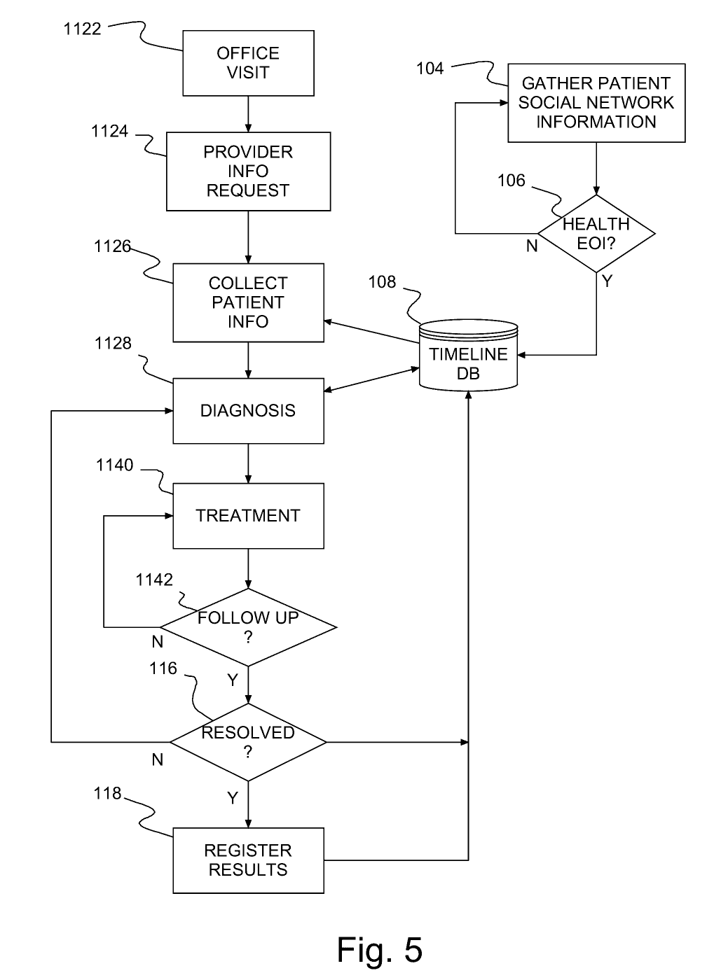

FIG. 5 shows an example of the treatment phase of FIG. 4 for a client (patient) visiting the doctor or medical facility 1122 for a new ailment with like features labeled identically. The provider requests 1124 the patient's timeline information, which the monitoring bot collects 1126 from the patients' timeline database 108. The provider diagnoses the problem 112 and prescribes 1128 a treatment 1140, e.g., medicine and therapy, and may indicate a follow up visit date. The patient begins 1140 treatment, while the monitoring bot continues to monitor 106 the patient's social media presence(s) for any EoIs reflecting medical status during treatment 1140. The monitoring bot logs any EoI information in the patients' timeline database 108.

The logged results 108 enrich the information normally available to the patients' healthcare providers. For example, the results may inform the provider how well his/her patient is reacting to (or even following) a given treatment, and provide providers with useful insights that correlate patient timeline EoIs with other general life events. When the follow-up visit arrives 1142, the provider re-examines the patient to determine if the treatment has been effective 116, or whether additional diagnosis 1128 and treatment 1140 is necessary. If the treatment has been effective 116, the monitoring bot registers 118 and logs the final results.

Thus, for example, a preferred monitoring and evaluation system allows a physician to check on how a chronic patient is responding to a new treatment. Depending on EoIs reported for that patient's presence on social media/network(s), the doctor may be able to verify the patient's adherence to the treatment with detected EoI's treated as a diary of the patient's symptoms. The supplemented patient information provides the doctor with near real time feedback for assessing the impact that the current, on-going treatment has on the patient based on social activities. By determining the efficacy of the treatment, the doctor can decide whether to continue the current treatment, or select another treatment that better fits the patient's responses to the current treatment without waiting for a return visit.

In the evaluation phase the preferred monitoring and evaluation system provides for objectively evaluating multiple aspects of treatment including, for example, the effectiveness of a particular physician, location, or healthcare provider. In this phase insurance providers, for example, may avail themselves of collected provider information from the patients' timeline database 108 to analyze the overall treatment.

Analysis begins when a requestor, e.g., an insurance provider, places an analysis request 120 with an evaluation bot. Again, the evaluation bot may be present locally on a local computer (e.g., 10) at a requester's location, or remotely, e.g., analytics processing 68 on a cloud computer 10 in cloud 50 with, or separate from, the monitoring bot. The evaluation bot filters the EoI information according to the request to collect 122 provider information. The evaluation bot ranks filtered results, e.g., based on treatment success frequency by the physicians. Once analysis is complete, the evaluation bot returns 124 the ranked information to the requestor.

So, for example, a health insurance company may wish to rank doctors best to worst, based on successful treatment results. The insurance company can request a ranking of doctors that successfully treated the largest number of patents with specific symptoms. The evaluation bot filters the patients' timeline database 108 information according to symptoms to identify patients that had the specified symptoms, and according to EoI, to determine how the symptoms were mitigated. Thus, considering the success of prescribed treatments for the ranked physicians, the insurance company can leverage provider relationships to favor the highest ranked doctors for the company.

Advantageously, the preferred bots collect and analyze data for clients and service providers (e.g., patients and doctors) to provide useful insights for correlating between client timeline EoIs and other general life events. For a healthcare provider the bots combines symptom reporting, both inside and outside of the healthcare facility, with life events and health related EoIs. The collected patient data enriches the information previously available to physicians, clinics, hospitals, and other healthcare providers. Thus, the bots provide physicians with an enriched view of patient history that may inform the healthcare provider as to how well a patient is reacting to, or even following, a given treatment, and indicate whether given symptoms are receding. Subsequently analyzing the aggregated information, filtered for example for a particular physician providing treatment, treatment location, and healthcare provider practice, provides to service provider consumers, e.g., patients and insurers, with a valuable decision making tool.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A service monitoring and evaluation system comprising:
a client timeline storage storing service provider client information indicating the effectiveness of services being provided by one or more service provider to one or more identified service provider clients, each said one or more service provider having access to stored service provider client information for respective identified service provider clients; and
a monitoring bot searching social media for any Event of Interest (EoI) related to any of said identified service provider clients, said monitoring bot extracting any service effectiveness information from any identified EoI, said monitoring bot storing extracted said effectiveness information in said client timeline storage, wherein the service providers are made aware of service effectiveness being provided to respective clients while said service is being provided to said respective clients.

2. A service monitoring and evaluation system as in claim 1, wherein said service providers are health care providers, and said clients are patients being treated by said health care providers.

3. A service monitoring and evaluation system as in claim 1, further comprising an evaluation bot filtering EoI information in said client timeline storage responsive to a request for a service provider evaluation, said evaluation bot collecting and filtering service effectiveness information for service provided by said service provider and returning filtered said information to said requestor.

4. A service monitoring and evaluation system as in claim 4, wherein said service providers are health care providers, said clients are patients being treated by said health care providers, and requesters include requesting effectiveness evaluation of aspects of treatment provided by said health care providers.

5. A service monitoring and evaluation system as in claim 4, wherein aspects of treatment include the physician providing treatment, treatment location, and healthcare provider practice.

6. A service monitoring and evaluation system as in claim 4, wherein said client timeline storage, said monitoring bot and said evaluation bot are located on a service monitoring and evaluation computer at a location separate from the healthcare provider practices and the insurance providers.

7. A method of monitoring and evaluating services, said method comprising:
scheduling an appointment for a client with a service provider;
determining service to meet the needs of said client responsive to client input and client history;
commencing determined service and monitoring said client's presence in social media for any Event of Interest (EoI) related to said determined service;
logging service related EoI information in client timeline storage;
making said service related EoI information available to said service provider, said service provider being apprised of the effectiveness of said determined service; and
said service provider selectively modifying said determined service responsive to said effectiveness.

8. A method as in claim 7, a monitoring bot monitoring said client's presence in social media, logging service related EoI information, and making said service related EoI information available to said service provider.

9. A method as in claim 8, before scheduling said appointment said method further comprising:
identifying said client with said monitoring bot; said monitoring bot gathering information about said client from said social media;
identifying every EoI in the gathered said information;
determining whether each EoI is related to the service needs of said client; and
adding to said client timeline storage information for said each EoI determined related to the service needs of said client.

10. A method as in claim 9, wherein said service providers are health care providers, and said clients are patients being treated by said health care providers.

11. A method as in claim 7 further comprising:
requesting service provider analysis from an evaluation bot; said evaluation bot
filtering EoI information in said client timeline storage for service effectiveness for service provided by said service provider responsive to said request;
collecting service effectiveness information for said service provider; and
providing collected said service effectiveness information to the requestor.

12. A method as in claim 11, wherein said service providers are health care providers, said clients are patients being treated by said health care providers, and requesters include requesting effectiveness evaluation of aspects of treatment provided by said health care providers.

13. A method system as in claim 12, wherein aspects of treatment include the physician providing treatment, treatment location, and healthcare provider practice.

14. A computer program product for monitoring and evaluating services, said computer program product comprising a non-transitory computer usable medium having computer readable program code stored thereon, said computer readable program code causing one or more computers executing said code to:
schedule an appointment for a client with a service provider;
determine a service to meet the needs of said client responsive to client input and client history;
commence determined service and monitoring said client's presence in social media for any Event of Interest (EoI) related to said determined service;
log service related EoI information in client timeline storage;
make said service related EoI information available to said service provider, said service provider being apprised of the effectiveness of said determined service; and said service provider selectively modify said determined service responsive to said effectiveness.

15. A computer program product for monitoring and evaluating services as in claim 14, said computer readable program code causing one of said one or more computers to provide a monitoring bot, said monitoring bot:
receiving an identify for said client;
gathering information about said client from said social media;
identifying every EoI in the gathered said information;
determining whether each EoI is related to the service needs of said client; and
adding to said client timeline storage information for said each EoI determined related to the service needs of said client.

16. A computer program product for monitoring and evaluating services as in claim 15, wherein said service providers are health care providers, and said clients are patients being treated by said health care providers.

17. A computer program product for monitoring and evaluating services as in claim 16, said computer readable program code causing one of said one or more computers to provide an evaluation bot, said evaluation bot:
receive a request for service provider analysis;
filter EoI information in said client timeline storage for service effectiveness for service provided by said service provider responsive to said request;
collect service effectiveness information for said service provider; and
provide collected said service effectiveness information to the requestor.

18. A computer program product for monitoring and evaluating services as in claim 17, wherein said service providers are health care providers, said clients are patients being treated by said health care providers, and requesters include requesting effectiveness evaluation of aspects of treatment provided by said health care providers.

19. A computer program product for monitoring and evaluating services system as in claim 18, wherein aspects of treatment include the physician providing treatment, treatment location, and healthcare provider practice.
